(19) United States
(12) Patent Application Publication
(10) Pub. No.: US 2024/0322490 A1
(43) Pub. Date: Sep. 26, 2024

(54) CONNECTOR AND WIRING HARNESS

(71) Applicant: SUMITOMO WIRING SYSTEMS, LTD., Mie (JP)

(72) Inventor: Yosuke MORINAGA, Mie (JP)

(21) Appl. No.: 18/599,997

(22) Filed: Mar. 8, 2024

(30) Foreign Application Priority Data
Mar. 22, 2023 (JP) 2023-045552

(51) Int. Cl. H01R 13/639; B60R 16/02; H01B 7/00; H01R 13/24; H01R 13/502; H01R 13/52

(52) U.S. Cl. CPC H01R 13/639; H01B 7/0045; H01R 13/2407; H01R 13/5025; H01R 13/5205; B60R 16/0215

(57) ABSTRACT

A connector 30 includes a terminal 31 to be connected to an end part of a wire 20 and a housing 40 including an accommodating portion 50X for accommodating the terminal 31 along a first direction X1 inside and a tube portion 60 open in a second direction Y2 intersecting the first direction X1 and communicating with the accommodating portion 50X. The connector 30 is provided with a sealing member 70 mounted on an outer periphery of the tube portion 60 and a retainer 80 for preventing detachment of the sealing member 70 from the housing 40. The retainer 80 includes a terminal position assuring portion 86 for restricting a movement of the terminal 31 in a first opposite direction X2 opposite to the first direction X1.

### CROSS-REFERENCE TO RELATED APPLICATIONS

This application is based on and claims priority from Japanese Patent Application No. 2023-045552, filed on Mar. 22, 2023, with the Japan Patent Office, the disclosure of which is incorporated herein in its entirety by reference.

### TECHNICAL FIELD

The present disclosure relates to a connector and a wiring harness.

### BACKGROUND

Conventionally, a connector provided with a housing and a terminal held in the housing is known as a connector to be installed in a vehicle. An end part of a wire is electrically connected to the terminal. A mating connector to be connected to the connector is provided with a mating terminal to be electrically connected to the terminal by being inserted into the connector.

Some of such connectors may be configured such that the mating terminal is inserted along a direction intersecting an insertion direction of the terminal and the wire into the housing (see, for example, US Patent Publication No. 2019/0173220 A). The connector of this type is provided with a terminal position assuring (TPA) member to be assembled with the housing.

### SUMMARY

In the above connector, an improvement in assembly workability is desired.

The present disclosure aims to provide a connector and a wiring harness capable of improving assembly workability.

This object is solved according to the invention by the features of the independent claims. Particular embodiments of the invention are subject of the dependent claims.

The present disclosure is directed to a connector, comprising: at least one terminal to be connected to at least one wire; a housing including at least one accommodating portion for at least partly accommodating the terminal along a first direction substantially inside and a tube portion substantially open in a second direction intersecting the first direction, the tube portion communicating with the accommodating portion; at least one sealing member mounted to the tube portion particularly on an outer periphery of the tube portion; and at least one retainer for preventing detachment of the sealing member from the housing, the retainer including at least one terminal position assuring portion for restricting a movement of the terminal in a first opposite direction opposite to the first direction.

The present disclosure particularly is directed to a connector with a terminal to be connected to an end part of a wire, a housing including an accommodating portion for accommodating the terminal along a first direction inside and a tube portion open in a second direction intersecting the first direction, the tube portion communicating with the accommodating portion, a sealing member mounted on an outer periphery of the tube portion, and a retainer for preventing detachment of the sealing member from the housing, the retainer including a terminal position assuring portion for restricting a movement of the terminal in a first opposite direction opposite to the first direction.

First, embodiments of the present disclosure are listed and described.

The connector of the present disclosure particularly is provided with a terminal to be connected to an end part of a wire, a housing including an accommodating portion for accommodating the terminal along a first direction inside and a tube portion open in a second direction intersecting the first direction, the tube portion communicating with the accommodating portion, a sealing member mounted on an outer periphery of the tube portion, and a retainer for preventing detachment of the sealing member from the housing, the retainer including a terminal position assuring portion for restricting a movement of the terminal in a first opposite direction opposite to the first direction.

According to this configuration, the retainer for retaining the sealing member is provided with the terminal position assuring portion for restricting the movement of the terminal in the first opposite direction. In this way, one component, i.e. the retainer, can have a function of retaining the sealing member and a function of assuring the position of the terminal by restricting the movement of the terminal in the first opposite direction. Thus, the number of components of the connector can be reduced as compared to the case where the function of retaining the sealing member and the terminal position assuring function are respectively given to different members. As a result, assembling man-hours of the connector can be reduced, wherefore the assembly workability of the connector can be improved.

Particularly, the housing may include one or more, particularly a plurality of protrusions substantially projecting in the second direction from an end surface in the second direction of the tube portion, and the retainer may include one or more, particularly a plurality of fitting holes, the plurality of protrusions at least partly being fit into the fitting holes.

According to this configuration, the one or more protrusions are provided on the end surface in the second direction of the tube portion. Thus, a separation distance of the sealing member from the housing can be made longer by the one or more protrusions as compared to the case where the one or more protrusions are not provided. In this way, the detachment of the sealing member from the housing can be suitably suppressed in a state before the retainer is mounted on the housing.

Further particularly, an outer peripheral edge of the tube portion may be formed to substantially have a rectangular or polygonal plan view shape when viewed from the second direction, and the plurality of protrusions may be provided at least on four corners of the rectangular or polygonal shape.

According to this configuration, the protrusions are provided at least on the four corners of the rectangular or polygonal outer peripheral edge of the tube portion. Thus, even if the sealing member moves to the plurality of protrusions in the second direction, the shape of the sealing member can be suitably maintained substantially in the same shape as when the sealing member is mounted on the outer periphery of the tube portion, i.e. in a rectangular or polygonal tubular shape.

Further particularly, the retainer may include a body portion formed into a frame shape, the body portion covering the end surface in the second direction of the tube portion, the terminal position assuring portion projecting in a second opposite direction substantially opposite to the second direction from the body portion, and at least one retaining portion projecting radially outwardly of the body portion from the body portion, and the retaining portion may be provided to be engageable with the sealing member substantially in the second direction.

According to this configuration, the retaining portion substantially projecting radially outward from the frame-shaped body portion is provided to be engageable with the sealing member substantially in the second direction. Thus, a movement of the sealing member substantially in the second direction is restricted by the retaining portion. In this way, the detachment of the sealing member from the housing can be suitably suppressed. Further particularly, the retainer may include at least one guide protrusion projecting substantially in the second opposite direction from the body portion, the housing may include at least one guide recess at least partly to be fit to the guide protrusion, and a projection amount of the guide protrusion from the body portion may be larger than that of the terminal position assuring portion from the body portion.

According to this configuration, the guide protrusion having the larger projection amount than the terminal position assuring portion is provided on the retainer, and the guide recess to be at least partly fit to the guide protrusion is provided in the housing. Thus, when the retainer is mounted on or to the housing, the terminal position assuring portion can be at least partly inserted into the accommodating portion of the housing with the guide protrusion at least partly fit in the guide recess. In this way, the terminal position assuring portion can be at least partly inserted into the accommodating portion with the retainer suitably maintained in a desired posture with respect to the housing.

Further preferably, the retainer may include at least one reinforcing portion continuously and integrally formed with the terminal position assuring portion to reinforce the terminal position assuring portion, the reinforcing portion may project substantially in the second opposite direction from the body portion, and a projection amount of the reinforcing portion from the body portion may be smaller than that of the terminal position assuring portion from the body portion.

According to this configuration, the retainer is provided with the at least one reinforcing portion for reinforcing the terminal position assuring portion. In this way, the strength of the terminal position assuring portion can be improved.

Further preferably, the retainer may include a first engaging portion for temporarily fixing the retainer to the tube portion without the terminal position assuring portion being inserted in the accommodating portion, and/or a second engaging portion for fixing the retainer to the tube portion with the terminal position assuring portion inserted in the accommodating portion and the movement of the terminal in the first opposite direction restricted.

According to this configuration, the first engaging portion for temporarily fixing the retainer to the tube portion is provided on the retainer. Since the terminal position assuring portion is not inserted in the accommodating portion in the temporarily fixed state, the terminal position assuring portion is not engaged with the terminal in the first direction. Thus, the terminal can be at least partly inserted into the accommodating portion of the housing after the retainer is temporarily fixed to the tube portion.

Further particularly, the housing may include at least one inner housing, in particular at least one substantially tubular inner housing, for at least partly accommodating the terminal inside, and an outer housing including the accommodating portion for at least partly accommodating the at least one inner housing inside, the inner housing may have an engaging surface formed to be engageable with the terminal position assuring portion in the first direction, and the terminal position assuring portion may restrict a movement of the inner housing in the first opposite direction.

According to this configuration, the movement of the inner housing in the first opposite direction is restricted by engaging the engaging surface of the inner housing and the terminal position assuring portion of the retainer. In this way, the movement of the terminal accommodated inside the inner housing in the first opposite direction can be suitably restricted.

Further particularly, the tube portion may include at least one through hole, the terminal position assuring portion being at least partly inserted into the through hole along a second opposite direction substantially opposite to the second direction, and the through hole may penetrate through the tube portion in the second direction and communicate with the accommodating portion.

According to this configuration, the tube portion is provided with the at least one through hole communicating with the accommodating portion. Thus, the terminal position assuring portion can be suitably at least partly inserted into the accommodating portion through the through hole(s) of the tube portion.

A wiring harness of the present disclosure is provided with the connector as described above, and the wire connected to the connector.

According to this configuration, effects similar to those of the connector described above can be obtained.

According to a connector and a wiring harness of the present disclosure, an effect of being able to improve assembly workability is achieved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic perspective view showing a wiring harness of one embodiment.

FIG. 2 is a schematic exploded perspective view showing the wiring harness of the embodiment.

FIG. 3 is a schematic plan view showing the wiring harness of the embodiment.

FIG. 4 is a schematic section (section along 4-4 in FIG. 3) showing the wiring harness of the embodiment.

FIG. 5 is a schematic section (section along 5-5 in FIG. 3) showing the wiring harness of the embodiment.

FIG. 6 is a schematic exploded perspective view showing the wiring harness of the embodiment.

FIG. 7 is a schematic perspective view showing a retainer of the embodiment.

FIG. 8 is a schematic perspective view in section showing the wiring harness of the embodiment.

FIG. 9 is a schematic section showing the wiring harness of the embodiment.

FIG. 10 is a schematic perspective view in section showing the wiring harness of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

Specific examples of a connector and a wiring harness of the present disclosure are described below with reference to the drawings. For the convenience of description, some components may be shown in an exaggerated or simplified manner in each drawing. Further, a dimension ratio of each part may be different in each figure. “Parallel” and “orthogonal” in this specification mean not only strictly parallel and orthogonal, but also substantially parallel and orthogonal within a range in which functions and effects in this embodiment are achieved. A term “tubular” used in the description of this specification indicates not only a shape formed by a peripheral wall continuous over an entire periphery in a circumferential direction, but also a shape formed by combining a plurality of components and a shape having a cut or the like in a circumferential part such as a C shape. Further, the “tubular” shapes include substantially circular shapes, elliptical shapes and polygonal shapes with angular or rounded corners, but there is no limitation to these. “Facing each other” in this specification indicates that surfaces or members are at positions substantially in front of each other, and means not only a case where the surfaces or members are at positions perfectly in front of each other, but also a case where the surfaces or members are partially in front of each other. Further, “facing each other” in this specification means both a case where another member different from two parts at least partly is interposed between the two parts and a case where nothing is interposed between the two parts. Further, terms “first”, “second” and “third” and the like in this specification are merely used to distinguish objects and do not rank the objects. Note that the present invention is not limited to these illustrations, but is represented by claims and intended to include all changes in the scope of claims and in the meaning and scope of equivalents.

### (Overall Configuration of Wiring Harness 10)

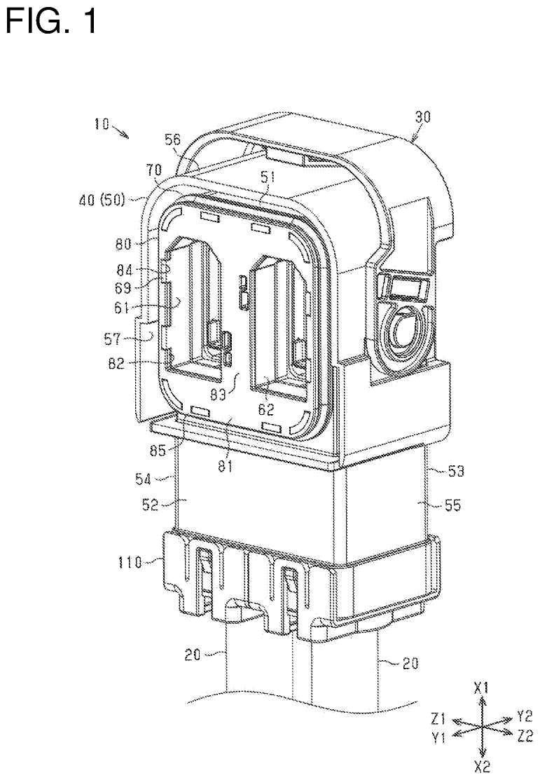

As shown in FIG. 1, a wiring harness 10 includes one or more (two in this embodiment) wires 20 and at least one connector 30 mounted on end part(s) of the wire(s) 20.

The wiring harness 10 is, for example, to be provided in a vehicle such as a hybrid or electric vehicle. The wiring harness 10 is, for example, for connecting electrical devices for vehicle such as a high-voltage battery, an inverter and/or a motor for wheel drive.

The connector 30 is, for example, connected to one electrical device. Although not shown, the connector 30 is or may be electrically connected to a mating connector provided on the electrical device. The mating connector is, for example, provided with one or more (e.g. two) mating terminals and a mating housing for holding the one or more (e.g. two) mating terminals.

Note that a vertical direction and a lateral direction in each figure does not necessary indicate postures of the connector 30 and the wiring harness 10 during use.

### (Overall Configuration of Connector 30)

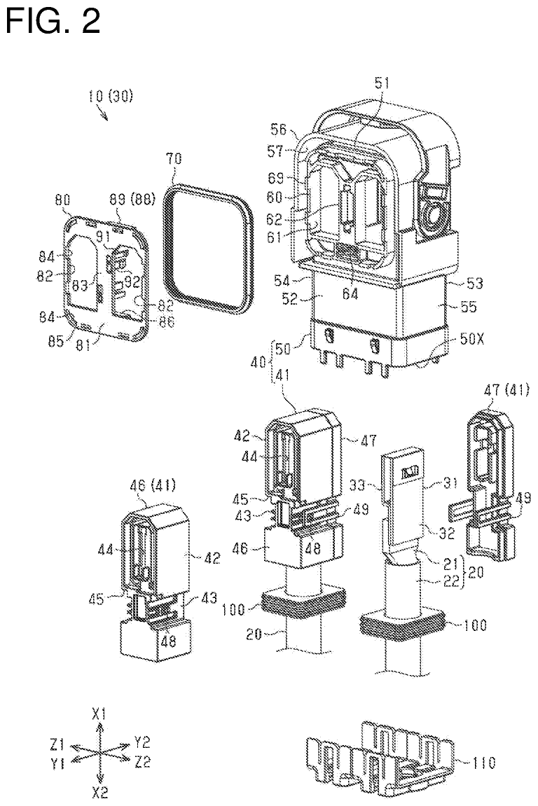

As shown in FIG. 2, the connector 30 is provided with one or more, particularly a plurality of terminals 31 respectively connected to one or more end parts of the one or more, particularly the plurality of wires 20 and a housing 40 for at least partly accommodating the one or more, particularly the plurality of terminals 31 inside.

Specifically, the housing 40 is provided with one or more inner housings 41 for at least partly accommodating the terminal(s) 31 inside and an outer housing 50 including an accommodating portion 50X for at least partly accommodating the one or more inner housings 41 inside.

The terminals 31 at least partly are inserted along a first direction X1 into the accommodating portion 50X of the outer housing 50. The outer housing 50 includes a tube portion 60 open in a second direction Y1 intersecting or arranged at an angle different from 0° or 180° with respect to the first direction X1 and/or communicating with the accommodating portion 50X.

The second direction Y1 of this embodiment particularly is a direction substantially orthogonal to the first direction X1.

The connector 30 is provided with at least one sealing member 70 mounted on (particularly the outer periphery of) the tube portion 60 and/or at least one retainer 80 for preventing the detachment of the sealing member 70 from the housing 40.

The connector 30 is, for example, provided with one or more (two in this embodiment) sealing members 100 mounted on (particularly the outer peripheries of) the wire(s) 20 and/or a back retainer 110 for preventing the detachment of the sealing members 100.

In describing a relationship of each constituent element of the wiring harness 10 below, a direction substantially opposite to the first direction X1 is referred to as a first opposite direction X2, and a direction substantially opposite to the second direction Y1 is referred to as a second opposite direction Y2.

Further, out of directions substantially orthogonal to both the first and second directions X1, Y1, a leftward direction in FIG. 2 is referred to as a third direction Z1, and a direction opposite to the third direction Z1 is referred to as a third opposite direction Z2.

Each direction described above is a direction in a state where the connector 30 is assembled with the end parts of the wires 20 unless otherwise specified.

The connector 30 is, for example, connected or connectable to the mating connector substantially along the second direction Y1. For example, the one or more mating terminals of the mating connector at least partly are inserted into the tube portion 60 substantially along the second opposite direction Y2, and/or the mating housing of the mating connector is fit to (particularly substantially outside) the tube portion 60 substantially along the second opposite direction Y2.

### (Configuration of Wires 20)

The (particularly each) wire 20 includes at least one electrically conductive core wire 21 and an insulating insulation coating 22 at least partly surrounding the outer periphery of the core wire 21.

Each wire 20 particularly may be a shielded wire having an electromagnetic shielding structure itself or may be a non-shielded wire having no electromagnetic shielding structure itself. Each wire 20 of this embodiment particularly is a non-shielded wire.

A stranded wire formed by twisting a plurality of metal strands or a single core wire composed of a single conductor can be, for example, used as the core wire 21.

A columnar conductor particularly formed from one columnar metal bar having a solid inner structure or a tubular conductor having a hollow inner structure can be, for example, used as the single core wire.

Further, a stranded wire, a columnar conductor and a tubular conductor may be used in combination as the core wire 21.

A copper-based or aluminum-based metal material particularly can be, for example, used as a material of the core wire 21.

The insulation coating 22 at least partly covers, for example, the outer peripheral surface of the core wire 21 particularly over part of or an entire circumference in a circumferential direction. The insulation coating 22 is, for example, made of an insulating resin material.

A cross-sectional shape of the wire 20 along a plane orthogonal to a length direction of the wire 20, i.e. a transverse cross-sectional shape of the wire 20 can be an arbitrary shape. The transverse cross-sectional shape of the wire 20 substantially can be, for example, a circular shape, a semicircular shape, a polygonal shape or a flat shape. The transverse cross-sectional shape of the wire 20 of this embodiment particularly substantially is a circular shape.

Each wire 20 particularly substantially extends along the first direction X1. In other words, an axial direction of each wire 20 particularly substantially extends in parallel to the first direction X1. The plurality of wires 20 are, for example, substantially arranged in the third direction Z1.

An end part in the axial direction (here, first direction X1) of the core wire 21 is exposed from the insulation coating 22. The terminal 31 is connected to the end part of the core wire 21 exposed from the insulation coating 22.

### (Configuration of Terminals 31)

The one or more (e.g. two) terminals 31 are respectively electrically connected to the one or more (e.g. two) respective wires 20.

The (particularly each) terminal 31 particularly includes, for example, a wire connecting portion 32 to be connected to (particularly the end part of) the wire 20 and a terminal connecting portion 33 to be connected to the unillustrated mating terminal.

Each terminal 31 is, for example, formed such that the wire connecting portion 32 and the terminal connecting portion 33 particularly substantially are connected in the first direction X1.

Each terminal 31 is, for example, made of metal. Metal materials such as copper, copper alloy, aluminum, aluminum alloy and stainless steel can be, for example, used as a material of each terminal 31.

The wire connecting portion 32 is connected or connectable to (particularly the end part of) the core wire 21 exposed from the insulation coating 22. The wire connecting portion 32 is, for example, connected or connectable to the core wire 21 particularly by crimping, bending, folding and/or ultrasonic welding. In this way, the wire connecting portion 32 and the core wire 21 are electrically and mechanically connected.

The terminal connecting portion 33 is, for example, substantially formed into a tubular shape as a whole.

The tubular terminal connecting portion 33 substantially is, for example, open in the second direction Y1.

The unillustrated mating terminal is to be at least partly inserted into the tubular terminal connecting portion 33, for example, substantially along the second opposite direction Y2.

The terminal connecting portion 33 is electrically and/or mechanically connected to the unillustrated mating terminal.

### (Configuration of Inner Housings 41)

The housing 40 includes one or more (e.g. two) inner housings 41 respectively provided to correspond to the one or more (e.g. two) wires 20.

The one or more inner housings 41 are, for example, made of synthetic resin. The inner housings 41 are, for example, components separate from the outer housing 50.

The (particularly each) inner housing 41 particularly substantially is formed into a tubular shape as a whole. The (each) inner housing 41 includes, for example, a terminal accommodating portion 42 for at least partly accommodating the terminal connecting portion 33 of the terminal 31 and/or at least one wire accommodating portion 43 for at least partly accommodating a connected part of the wire connecting portion 32 of the terminal 31 and/or the core wire 21 of the wire 20.

The (each) inner housing 41 is, for example, substantially open in the first opposite direction X2.

The (each) inner housing 41 particularly includes, for example, at least one insertion hole 44 substantially open in the second direction Y1. The insertion hole 44 particularly is so formed that the unillustrated mating terminal at least partly is insertable thereinto.

The insertion hole 44 particularly is formed to allow communication between the inside and the outside of the inner housing 41.

The (each) inner housing 41 particularly has at least one engaging surface 45 formed to be engageable with at least one terminal position assuring portion 86 of the retainer 80 in the first direction X1. The engaging surface 45 is, for example, provided in a connected part of the terminal accommodating portion 42 and the wire accommodating portion 43.

The (particularly each) inner housing 41 particularly is composed of a plurality of (two in this embodiment) divided bodies, i.e. at least a first divided body 46 and a second divided body 47. The (each) inner housing 41 particularly substantially is formed into a tubular shape at least partly surrounding the outer periphery of the terminal 31 particularly by assembling the first and second divided bodies 46, 47.

The first divided body 46 is, for example, provided further or offset in the second direction Y1 than the second divided body 47.

The first divided body 46 is, for example, substantially open in the first opposite direction X2 and open in the second opposite direction Y2.

A part constituting the terminal accommodating portion 42, out of the first divided body 46, particularly includes the insertion hole 44. The part constituting the terminal accommodating portion 42, out of the first divided body 46, has, for example, the at least one engaging surface 45.

A part constituting the wire accommodating portion 43, out of the first divided body 46, has at least one engaging portion 48. The engaging portion 48 is or comprises, for example, at least one projection substantially projecting radially outwardly of the inner housing 41 (here, particularly third direction Z1 or third opposite direction Z2) from the outer surface of the first divided body 46.

The second divided body 47 is, for example, provided further or offset in the second opposite direction Y2 than the first divided body 46. The second divided body 47 is, for example, provided to at least partly close an opening in the second opposite direction Y2 of the first divided body 46.

A part constituting the wire accommodating portion 43, out of the second divided body 47, includes at least one engaging portion 49. The engaging portion 49 is or comprises, for example, a resilient piece substantially projecting toward the engaging portion 48 from the outer surface of the second divided body 47 and/or formed to be resiliently deformable in a radial direction of the inner housing 41.

The engaging portion 49 substantially is, for example, formed into a rectangular or polygonal frame body, and/or includes at least one engaging hole engageable with the engaging portion 48 in a center or intermediate portion of the frame body. The engaging portions 48, 49 are engaged or engageable with each other, for example, by snap fitting, particularly utilizing the resilient deformation of the engaging portion 49. By the engagement of the engaging portions 48, 49, a united state of the first and second divided bodies 46, 47 particularly is or can be maintained.

### (Configuration of Outer Housing 50)

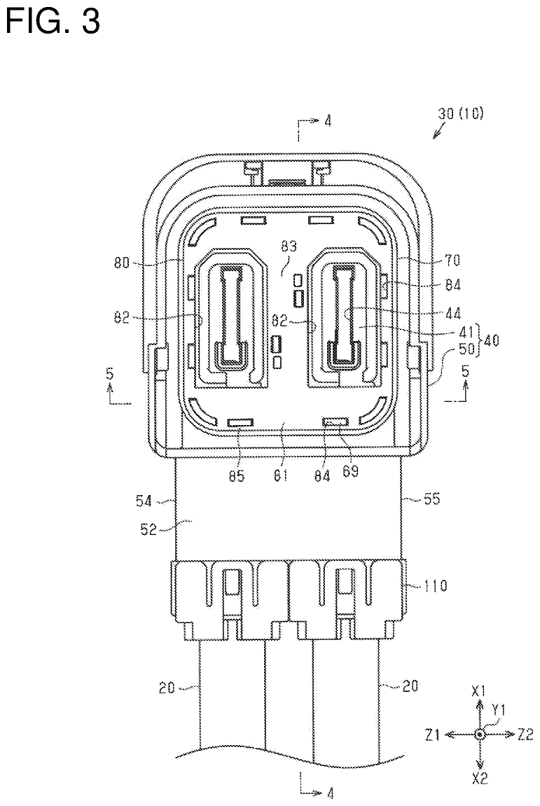

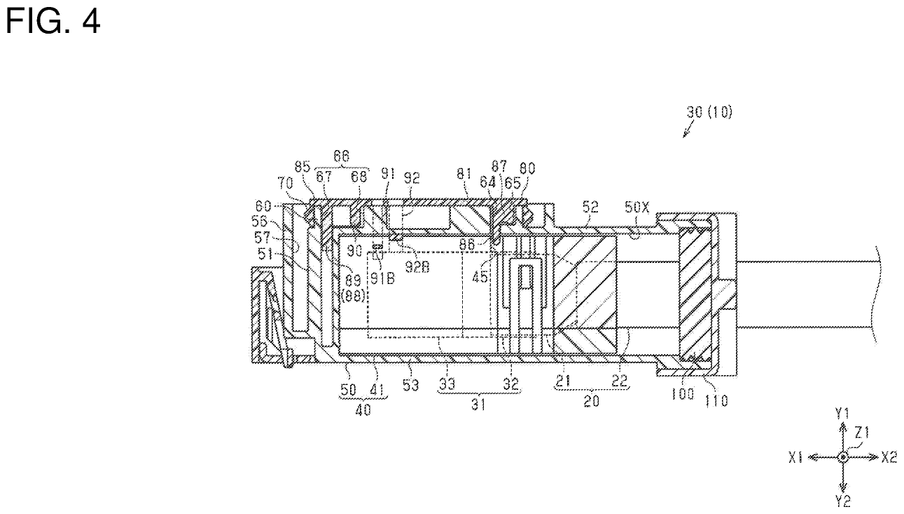

As shown in FIGS. 3 and 4, the outer housing 50 at least partly surrounds the one or more outer peripheries of the one or more inner housings 41.

The outer housing 50 is, for example, made of synthetic resin. The outer housing 50 is, for example, formed into a box or polygonal shape as a whole.

As shown in FIG. 4, the outer housing 50 includes the accommodating portion 50X for at least partly accommodating the one or more inner housings 41 inside. The accommodating portion 50X at least partly accommodates, for example, the one or more wires 20 pulled out from the one or more inner housings 41.

The accommodating portion 50X substantially is, for example, open in the first opposite direction X2.

An opening in the first direction X1 of the accommodating portion 50X particularly is at least partly closed by at least one peripheral wall 51.

As show in FIG. 2, the outer housing 50 particularly includes the peripheral wall 51 substantially provided on the first direction X1 side, at least one peripheral wall 52 substantially provided on the second direction Y1 side, and/or at least one peripheral wall 53 substantially provided on the second opposite direction Y2 side.

The outer housing 50 particularly includes a peripheral wall 54 substantially provided on the third direction Z1 side, and/or a peripheral wall 55 substantially provided on the third opposite direction Z2 side.

The outer housing 50 particularly includes the tube portion 60 provided in an outer surface (particularly substantially on or near an end part in the first direction X1 of) the peripheral wall 52.

The tube portion 60 particularly is a fitting tube portion, into which the mating housing of the unillustrated mating connector at least partly is fit or fittable.

The tube portion 60 projects radially outwardly (here, particularly substantially in the second direction Y1) of the outer housing 50 from the outer surface of the peripheral wall 52.

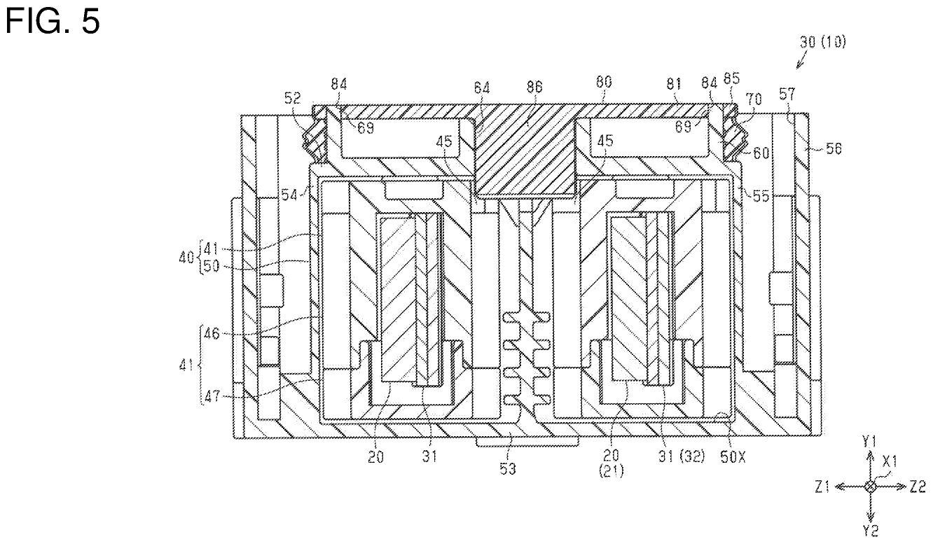

As shown in FIG. 5, the tube portion 60 particularly is formed to at least partly expose an outer surface on the outer peripheral edge of the peripheral wall 52. In other words, the tube portion 60 particularly is formed to substantially project in the second direction Y1 from the outer surface inwardly of the outer peripheral edge of the peripheral wall 52. In this way, a step particularly is formed by the outer peripheral surface of the tube portion 60 and the outer surface on the outer peripheral edge of the peripheral wall 52.

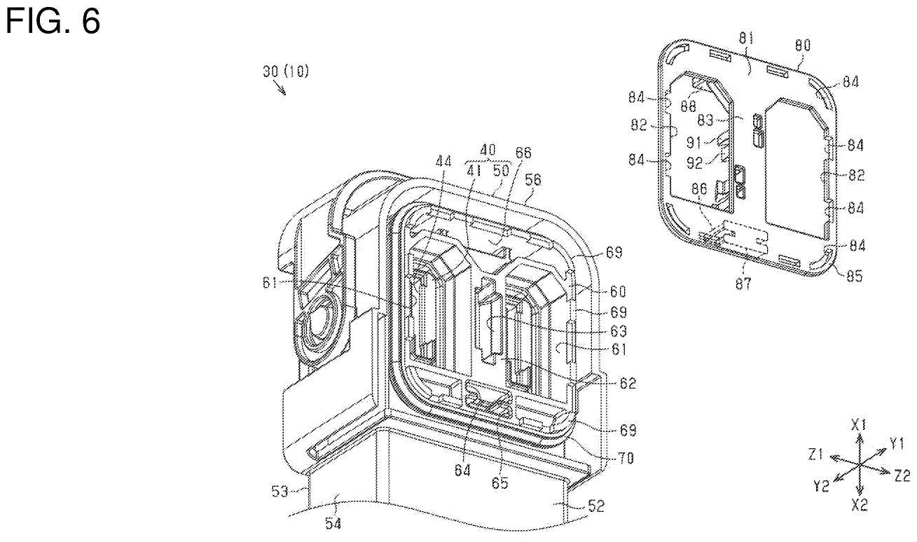

As shown in FIG. 6, the tube portion 60 is, for example, substantially formed into a tubular shape having at least one peripheral wall, particularly substantially continuous over the entire periphery of the tube portion 60 in a circumferential direction, i.e. a substantially endless structure in which a start point and an end point coincide. In other words, the tube portion 60 particularly is not formed with a hole allowing communication between the inside and the outside of the tube portion 60 such as a slit in a circumferential part.

The tube portion 60 is, for example, substantially formed into a rectangular or polygonal tube shape. The outer edge shape of the tube portion 60 is, for example, formed to substantially have a rectangular or polygonal plan view shape when viewed from the second direction Y1.

The outer edge shape of the tube portion 60 of this embodiment is, for example, formed to substantially have a rectangular plan view shape with rounded corners when viewed from the second direction Y1.

The tube portion 60 includes one or more insertion holes 61. The tube portion 60 of this embodiment includes two insertion holes 61. By including the one or more insertion holes 61, the tube portion 60 particularly is formed into a tubular shape.

The tube portion 60 includes, for example, at least one partition wall 62 partitioning between the plurality of (e.g. two) insertion holes 61. The plurality of (e.g. two) insertion holes 61 are, for example, formed to respectively expose the insertion holes 44 of the plurality of (e.g. two) inner housings 41.

The plurality of (e.g. two) insertion holes 61 particularly are provided apart from each other along the third direction Z1.

The (particularly each) insertion hole 61 is formed to substantially allow communication between the inside and the outside of the outer housing 50. The (particularly each) insertion hole 61 is, for example, substantially open in the second direction Y1 and/or substantially open in the second opposite direction Y2.

For example, the (each) insertion hole 61 penetrates through the tube portion 60 substantially in the second direction Y1 and/or penetrates through the peripheral wall 52 substantially in the second direction Y1.

The one or more partition wall 62 particularly is provided between the two or more insertion holes 61 substantially in the third direction Z1.

The partition wall 62 includes, for example, at least one engaging hole 63 particularly formed such that first engaging portion(s) 91 and/or second engaging portion(s) 92 of the retainer 80 at least party are insertable thereinto.

The engaging hole 63 particularly is formed to allow communication between the inside and the outside of the outer housing 50. For example, the at least one engaging hole 63 penetrates through the partition wall 62 substantially in the second direction Y1 and/or penetrates through the peripheral wall 52 substantially in the second direction Y1.

The engaging hole 63 is, for example, provided in a center or intermediate portion of the partition wall 62 in a plan view from the second direction Y1.

As shown in FIGS. 4 and 5, the tube portion 60 particularly includes at least one through hole 64, through which the terminal position assuring portion 86 of the retainer 80 is or can be passed.

The through hole 64 particularly is formed to allow communication between the inside and the outside of the outer housing 50. For example, the through hole 64 penetrates through the tube portion 60 substantially in the second direction Y1 and/or penetrates through the peripheral wall 52 substantially in the second direction Y1.

As shown in FIG. 6, the through hole 64 is, for example, provided further or offset in the first opposite direction X2 than the (two) insertion hole(s) 61. The through hole 64 extends, for example, substantially along the third direction Z1.

The through hole 64 is, for example, provided to partially overlap each insertion hole 61 substantially in the first direction X1.

As shown in FIG. 5, the through hole 64 is, for example, provided to partially overlap each inner housing 41 substantially in the second direction Y1.

As shown in FIG. 6, the tube portion 60 includes, for example, at least one recess 65 communicating with the through hole 64. The recess 65 is, for example, provided adjacent to the through hole 64 substantially in the first direction X1.

The recess 65 is, for example, formed to be recessed substantially in the second opposite direction Y2 from or near an end surface in the second direction Y1 of the tube portion 60.

As shown in FIG. 4, the recess 65 does not, for example, penetrate through the tube portion 60. The recess 65 is, for example, formed to be recessed from or near the end surface in the second direction Y1 of the tube portion 60 towards or to the outer surface of the peripheral wall 52. In other words, a part of the peripheral wall 52 particularly functions as a bottom wall for closing an opening substantially in the second opposite direction Y2 of the recess 65.

The tube portion 60 includes, for example, at least one guide recess 66. The guide recess 66 is, for example, formed to be recessed substantially in the second opposite direction Y2 from or near the end surface in the second direction Y1 of the tube portion 60.

The guide recess 66 is, for example, substantially provided further in the first direction X1 than the engaging hole 63 (see FIG. 6).

The guide recess 66 includes at least one first guide recess 67 and/or at least one second guide recess 68 formed to be shallower than the first guide recess 67.

The first guide recess 67 particularly is provided further or offset in the first direction X1 than the second guide recess 68. The first guide recess 67 is, for example, provided adjacent to the second guide recess 68 substantially in the first direction X1. For example, the first guide recess 67 particularly communicates with the second guide recess 68. The first guide recess 67 is, for example, formed to be recessed further in the second opposite direction Y2 than the outer surface of the peripheral wall 52.

The second guide recess 68 is, for example, formed to be recessed from or near the end surface in the second direction Y1 of the tube portion 60 to the outer surface of the peripheral wall 52. In other words, a part of the peripheral wall 52 particularly functions as a bottom wall for closing an opening in the second opposite direction Y2 of the second guide recess 68.

As shown in FIG. 6, the outer housing 50 includes, for example, one or more, particularly a plurality of protrusions 69 projecting substantially in the second direction Y1 from (particularly the end surface in the second direction Y1 of) the tube portion 60. The one or more, particularly the plurality of protrusions 69 particularly are provided on (particularly the outer peripheral edge of) the tube portion 60.

The plurality of protrusions 69 particularly are provided at intervals substantially along the circumferential direction of the tube portion 60.

Here, the outer peripheral edge of the tube portion 60 particularly is formed to have a rectangular or polygonal plan view shape when viewed from the second direction Y1.

The plurality of protrusions 69 particularly are provided at least on (e.g. four or more) corners of the rectangular or polygonal outer peripheral edge of the tube portion 60. Two protrusions 69 are, for example, provided on each of four sides of the rectangular outer peripheral edge of the tube portion 60. Each protrusion 69 particularly substantially extends along the circumferential direction of the tube portion 60.

The outer housing 50 includes, for example, at least one tubular receptacle 56 at least partly surrounding the outer periphery of the tube portion 60. The receptacle 56 surrounds the outer periphery of the tube portion 60, for example, over a substantially entire periphery particularly in the circumferential direction.

As shown in FIG. 5, the inner peripheral surface of the receptacle 56 particularly is provided apart from the outer peripheral surface of the tube portion 60. That is, the inner peripheral surface of the receptacle 56 at least partly surrounds the outer peripheral surface of the tube portion 60 with a gap 57 provided between the outer peripheral surface of the tube portion 60 and the inner peripheral surface of the receptacle 56. The gap 57 is, for example, formed to be continuous over the substantially entire periphery of the receptacle 56 particularly in the circumferential direction.

For example, with the unillustrated mating connector connected to the connector 30, the mating housing of the mating connector at least partly is inserted in the gap 57. Note that the (particularly each) protrusion 69 projects, for example, further in the second direction Y1 than an end surface in the second direction Y1 of the receptacle 56.

### (Configuration of Sealing Member 70)

The sealing member 70 particularly is mounted or mountable on (particularly the outer periphery of) the tube portion 60. The sealing member 70 particularly is or is to be provided in the gap 57. The sealing member 70 is, for example, provided between the outer surface of the outer peripheral edge of the peripheral wall 52 exposed from the tube portion 60 and the retainer 80 in the second direction Y1.

The sealing member 70 particularly is provided to be engageable with the outer surface of the peripheral wall 52 in the second direction Y1.

The sealing member 70 particularly is provided to be engageable with the retainer 80 substantially in the second direction Y1. The sealing member 70 particularly seals between the outer peripheral surface of the tube portion 60 and the inner peripheral surface of the mating housing of the mating connector when the unillustrated mating connector is connected to the connector 30.

The sealing member 70 particularly is configured to be resiliently deformable. The sealing member 70 is, for example, made of rubber or rubber-like resilient material.

As shown in FIG. 2, the sealing member 70 is, for example, formed substantially into a tubular shape by a peripheral wall continuous particularly over the substantially entire periphery of the tube portion 60 in the circumferential direction.

The inner peripheral shape of the sealing member 70 is, for example, formed into a shape substantially along the outer peripheral surface of the tube portion 60.

The outer peripheral shape of the sealing member 70 is, for example, formed into a shape substantially along the inner peripheral surface of the unillustrated mating housing. The sealing member 70 of this embodiment is in the form of a rectangular tube substantially having rectangular or polygonal inner and outer peripheral shapes.

### (Configuration of Retainer 80)

As shown in FIG. 6, the retainer 80 particularly includes a body portion 81, at least one retaining portion 85 for retaining the sealing member 70 and/or the at least one terminal position assuring portion 86 for restricting movements of the one or more terminals 31 (see FIG. 2) particularly substantially in the first opposite direction X2.

The retainer 80 includes, for example, at least one reinforcing portion 87, at least one guide protrusion 88, the first engaging portions 91 and/or the second engaging portions 92.

The retainer 80 is, for example, a single component in which the body portion 81, the retaining portion 85, the terminal position assuring portion 86, the reinforcing portion 87, the guide protrusion 88, the first engaging portions 91 and/or the second engaging portions 92 are continuously and integrally or unitarily formed.

The retainer 80 is, for example, made of synthetic resin.

The body portion 81 is, for example, substantially formed into a frame shape as a whole. The outer peripheral edge of the body portion 81 is, for example, formed to have a rectangular or polygonal plan view shape when viewed from the second direction Y1.

The outer peripheral edge of the body portion 81 of this embodiment particularly is formed to have a rectangular or polygonal plan view shape with rounded corners when viewed from the second direction Y1.

The body portion 81 is, for example, formed to at least partly cover the end surface in the second direction Y1 of the tube portion 60. The body portion 81 at least partly covers, for example, the end surface in the second direction Y1 of the outer peripheral edge of the tube portion 60 and/or an end surface in the second direction Y1 of the partition wall 62.

The body portion 81 includes one or more insertion holes 82. The body portion 81 of this embodiment particularly includes two insertion holes 82.

The body portion 81 includes, for example, a partitioning portion 83 partitioning between the two insertion holes 82. The two insertion holes 82 are, for example, formed to respectively substantially communicate with the two insertion holes 61 of the tube portion 60. The two insertion holes 82 are, for example, formed to respectively at least partly expose the insertion holes 44 of the two inner housings 41.

The two or more insertion holes 82 particularly are provided apart or spaced from each other in the third direction Z1. For example, each insertion hole 82 penetrates through the body portion 81 in the second direction Y1.

The partitioning portion 83 is provided between the adjacent (particularly two) insertion holes 82 substantially in the third direction Z1. The partitioning portion 83 particularly is provided to at least partly cover the end surface in the second direction Y1 of the partition wall 62.

The body portion 81 includes, for example, one or more, particularly a plurality of fitting holes 84. The plurality of fitting holes 84 are, for example, provided in the outer peripheral edge of the body portion 81.

The one or more, particularly the plurality of fitting holes 84 are, for example, provided to respectively face the one or more, particularly the plurality of protrusions 69. The plurality of fitting holes 84 particularly are provided to be respectively fittable to the plurality of protrusions 69.

The (particularly each) fitting hole 84 penetrates, for example, through the body portion 81 substantially in the second direction Y1.

The fitting holes 84 provided in the outer peripheral edge on the third direction Z1 side and the third opposite direction Z2 side of the body portion 81, here four fitting holes 84, particularly are formed to directly communicate with the insertion holes 82.

The at least one retaining portion 85 prevents the detachment of the sealing member 70 from the housing 40. The retaining portion 85 particularly substantially projects radially outwardly of the body portion 81 from the body portion 81. The retaining portion 85 projects, for example, further radially outwardly of the body portion 81 than the fitting hole(s) 84.

The retaining portion 85 is, for example, formed continuously over the entire periphery of the body portion 81 particularly substantially in the circumferential direction.

As shown in FIG. 5, the retaining portion 85 particularly projects further radially outwardly of the tubular portion 60 than the outer peripheral surface of the tube portion 60.

The retaining portion 85 particularly is provided to be able to contact an end surface in the second direction Y1 of the sealing member 70.

The retaining portion 85 particularly is provided to be engageable with the sealing member 70 in the second direction Y1.

The retaining portion 85 is, for example, provided to sandwich the sealing member 70 between the outer surface of the peripheral wall 52 exposed from the tube portion 60 and the retaining portion 85 in the second direction Y1. In other words, the sealing member 70 is provided between the retaining portion 85 and the outer surface of the peripheral wall 52 in the second direction Y1.

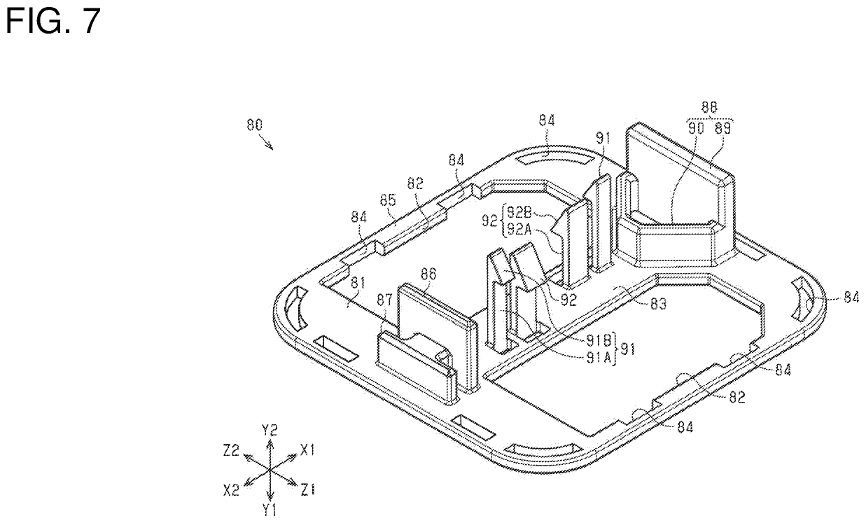

As shown in FIG. 7, the at least one terminal position assuring portion 86 particularly projects substantially in the second opposite direction Y2 specifically from an end surface in the second opposite direction Y2 of the body portion 81.

The terminal position assuring portion 86 is, for example, substantially formed into a plate shape. The terminal position assuring portion 86 is, for example, substantially in the form of a flat plate having a predetermined or predeterminable thickness in the first direction X1 and/or spreading or varying in the second direction Y1 and third direction Z1.

As shown in FIGS. 4 and 5, the terminal position assuring portion 86 particularly is formed to be at least partly insertable into the through hole 64 of the tube portion 60.

The terminal position assuring portion 86 particularly is passed through the through hole 64. The tip of the terminal position assuring portion 86 specifically projects further radially inwardly of the outer housing 50 than the inner surface of the peripheral wall 52. That is, the tip of the terminal position assuring portion 86 particularly at least partly is inserted in the accommodating portion 50X of the outer housing 50.

As shown in FIG. 4, the tip of the terminal position assuring portion 86 is, for example, provided to be engageable with the engaging surface(s) 45 of the inner housing(s) 41 in the first direction X1.

The terminal position assuring portion 86 particularly restricts movements of the inner housing(s) 41 substantially in the first opposite direction X2.

The terminal position assuring portion 86 particularly restricts movements of the terminal(s) 31 at least partly accommodated inside the inner housing(s) 41 substantially in the first opposite direction X2.

As shown in FIG. 7, the at least one reinforcing portion 87 particularly is provided to reinforce the terminal position assuring portion 86. The reinforcing portion 87 is continuously and/or integrally or unitarily formed with the terminal position assuring portion 86.

The reinforcing portion 87 projects, for example, in the second opposite direction Y2 from an end surface substantially in the second opposite direction Y2 of the body portion 81. The reinforcing portion 87 projects, for example, substantially in the first opposite direction X2 from an end surface in the first opposite direction X2 of the terminal position assuring portion 86.

The reinforcing portion 87 is, for example, substantially formed to have a T-shaped plan view shape when viewed from the second direction Y1.

A projection amount of the terminal position assuring portion 86 from the end surface in the second opposite direction Y2 of the body portion 81 is, for example, smaller than that of the terminal position assuring portion 86 from the end surface in the second opposite direction Y2 of the body portion 81. That is, a length of the reinforcing portion 87 along the second direction Y1 particularly is smaller than that of the terminal position assuring portion 86 along the second direction Y1.

As shown in FIG. 4, the reinforcing portion 87 is formed to be at least partly fittable into the recess 65 of the tube portion 60. The tip of the reinforcing portion 87 is, for example, formed to be able to contact the bottom surface of the recess 65.

The guide protrusion 88 particularly projects substantially in the second opposite direction Y2 from the end surface in the second opposite direction Y2 of the body portion 81.

The guide protrusion 88 particularly is formed to be at least partly fittable into the guide recess 66 of the tube portion 60. The guide protrusion 88 is, for example, provided substantially further in the first direction X1 than the terminal position assuring portion 86.

As shown in FIG. 7, the at least one guide protrusion 88 includes, for example, at least one first guide protrusion 89 and/or at least one second guide protrusion 90 continuously and/or integrally or unitarily formed with the first guide protrusion 89.

The first guide protrusion 89 particularly projects substantially in the second opposite direction Y2 from the end surface in the second opposite direction Y2 of the body portion 81.

The first guide protrusion 89 is, for example, formed into a plate shape. The first guide protrusion 89 is, for example, substantially in the form of a flat plate having a predetermined or predeterminable thickness in the first direction X1 and/or spreading or varying in the second direction Y1 and third direction Z1.

A projection amount of the first guide protrusion 89 from the end surface in the second opposite direction Y2 of the body portion 81 is, for example, larger than that of the terminal position assuring portion 86 from the end surface in the second opposite direction Y2 of the body portion 81. That is, a length of the first guide protrusion 89 along the second direction Y1 particularly is larger than that of the terminal position assuring portion 86 along the second direction Y1.

The thickness of the first guide protrusion 89, i.e. a length of the first guide protrusion 89 substantially along the first direction X1, is, for example, larger than that of the terminal position assuring portion 86, i.e. a length of the terminal position assuring portion 86 substantially along the first direction X1.

As shown in FIG. 4, the first guide protrusion 89 particularly is formed to be at least partly fittable into the first guide recess 67 of the tube portion 60. The tip of the first guide protrusion 89 particularly projects further radially inwardly of the outer housing 50 than the inner surface of the peripheral wall 52.

The first guide protrusion 89 particularly functions as a guide member in mounting the retainer 80 on the outer housing 50 by being at least partly inserted into the first guide recess 67.

As shown in FIG. 7, the at least one second guide protrusion 90 particularly is provided to reinforce the first guide protrusion 89.

The second guide protrusion 90 projects, for example, substantially in the second opposite direction Y2 from the end surface in the second opposite direction Y2 of the body portion 81.

The second guide protrusion 90 projects, for example, substantially in the first opposite direction X2 from an end surface in the first opposite direction X2 of the first guide protrusion 89.

The second guide protrusion 90 is, for example, formed into a frame shape. A projection amount of the second guide protrusion 90 from the end surface

substantially in the second opposite direction Y2 of the body portion 81 is, for example, smaller than that of the first guide protrusion 89 from the end surface substantially in the second opposite direction Y2 of the body portion 81. That is, a length of the second guide protrusion 90 along the second direction Y1 particularly is smaller than that of the first guide protrusion 89 along the second direction Y1.

As shown in FIG. 4, the second guide protrusion 90 particularly is formed to be at least partly fittable into the second guide recess 68 of the tube portion 60. The tip of the second guide protrusion 90 is, for example, formed to be able to contact the bottom surface of the second guide recess 68.

As shown in FIG. 7, the retainer 80 of this embodiment particularly includes one or more (e.g. two) first engaging portions 91 and one or more (e.g. two) second engaging portions 92. The (two) first engaging portion(s) 91 and the (two) second engaging portion(s) 92 are, for example, provided on an end surface in the second opposite direction Y2 of the partitioning portion 83.

The two or more first engaging portions 91 and the two or more second engaging portions 92 are, for example, provided apart from each other substantially along the first direction X1. The two second engaging portions 92 are, for example, provided between the two first engaging portions 91 in the first direction X1.

The (two) first engaging portion(s) 91 and the (two) second engaging portion(s) 92 are, for example, at least partly inserted into the engaging hole 63 (see FIG. 6) of the tube portion 60.

The (particularly each) first engaging portion 91 includes at least one resiliently deformable first resilient piece 91A projecting substantially in the second opposite direction Y2 from (particularly the end surface in the second opposite direction Y2 of) the partitioning portion 83 and/or at least one first engaging projection 91B provided on (particularly the projecting tip of) the first resilient piece 91A.

The first resilient piece 91A is, for example, in the form of a cantilever having a base end connected to the partitioning portion 83 as a fixed end and a tip on a side opposite to the base end as a free end.

The first resilient piece 91A is, for example, configured to be deflectable substantially in the third direction Z1 by being resiliently deformed.

The first engaging projection 91B projects, for example, in a direction (here, particularly third direction Z1 or third opposite direction Z2) at an angle different from 0° or 180°, particularly substantially orthogonal to a length direction of the first resilient piece 91A particularly from the tip of the first resilient piece 91A.

As shown in FIG. 7, the (particularly each) second engaging portion 92 includes at least one resiliently deformable second resilient piece 92A projecting substantially in the second opposite direction Y2 from (particularly the end surface in the second opposite direction Y2 of) the partitioning portion 83 and/or at least one second engaging projection 92B provided on (particularly the projecting tip of) the second resilient piece 92A.

The second resilient piece 92A is, for example, substantially in the form of a cantilever having a base end connected to the partitioning portion 83 as a fixed end and a tip on a side opposite to the base end as a free end.

The second resilient piece 92A is, for example, configured to be deflectable substantially in the third direction Z1 by being resiliently deformed.

The second engaging projection 92B projects, for example, in a direction (here, particularly third direction Z1 or third opposite direction Z2) at an angle different from 0° or 180°, particularly substantially orthogonal to a length direction of the second resilient piece 92A from the tip of the second resilient piece 92A.

A length of the second engaging portion 92 substantially along the second direction Y1 particularly is smaller than that of the first engaging portion 91 along the second direction Y1.

A shortest distance from the end surface in the second opposite direction Y2 of the partitioning portion 83 to the second engaging projection 92B particularly is shorter than that from the end surface in the second opposite direction Y2 of the partitioning portion 83 to the first engaging projection 91B.

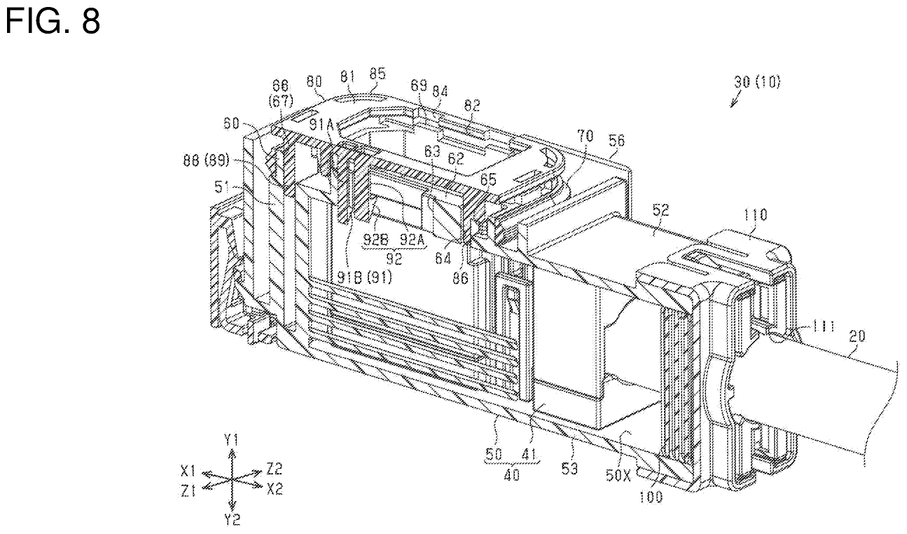

As shown in FIG. 8, the one or more first engaging projections 91B are formed to be engageable with the end surface in the second opposite direction Y2 of the partition wall 62.

For example, the first engaging projections 91B particularly are provided to be engageable with the end surface in the second opposite direction Y2 of the partition wall 62 earlier than the second engaging projections 92B when the retainer 80 is mounted on the outer housing 50.

The respective first engaging portions 91 and the partition wall 62 are, for example, engaged with each other particularly by snap fitting utilizing the resilient deformation of the first resilient pieces 91A.

The retainer 80 particularly is temporarily fixed to the outer housing 50 by the engagement of the respective first engaging portion(s) 91 and the partition wall(s) 62. In this temporarily fixed state, the retainer 80 is fixed to the outer housing 50 particularly with the body portion 81 of the retainer 80 lifted from the tube portion 60, i.e. with the body portion 81 separated from the end surface in the second direction Y1 of the tube portion 60.

In the temporarily fixed state, the second engaging projections 92B of the second engaging portions 92 particularly are not engaged with the end surface in the second opposite direction Y2 of the partition wall 62.

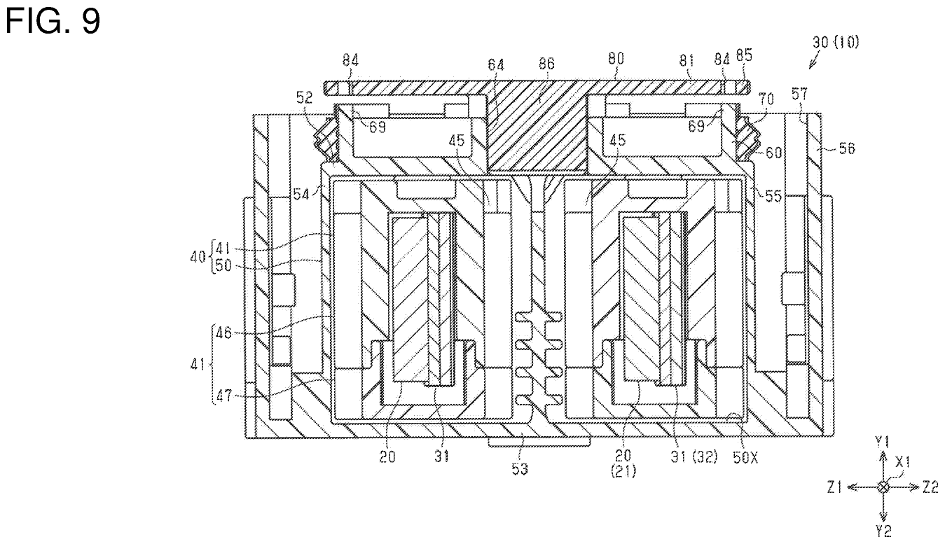

As shown in FIG. 9, in the temporarily fixed state, the tip of the terminal position assuring portion 86 particularly is not inserted in the accommodating portion 50X of the outer housing 50.

In the temporarily fixed state, the tip of the terminal position assuring portion 86 particularly is provided at a position not to be engageable with the engaging surfaces 45 of the inner housings 41 in the first direction X1. That is, the tip of the terminal position assuring portion 86 in the temporarily fixed state particularly is provided not to project further in the second opposite direction Y2 than the inner surface of the peripheral wall 52, i.e. the end surface in the second opposite direction Y2 of the peripheral wall 52.

In the temporarily fixed state, the terminal(s) 31 and the inner housing(s) 41 at least partly accommodating the terminal(s) 31 particularly are at least partly insertable into the outer housing 50 substantially along the first direction X1.

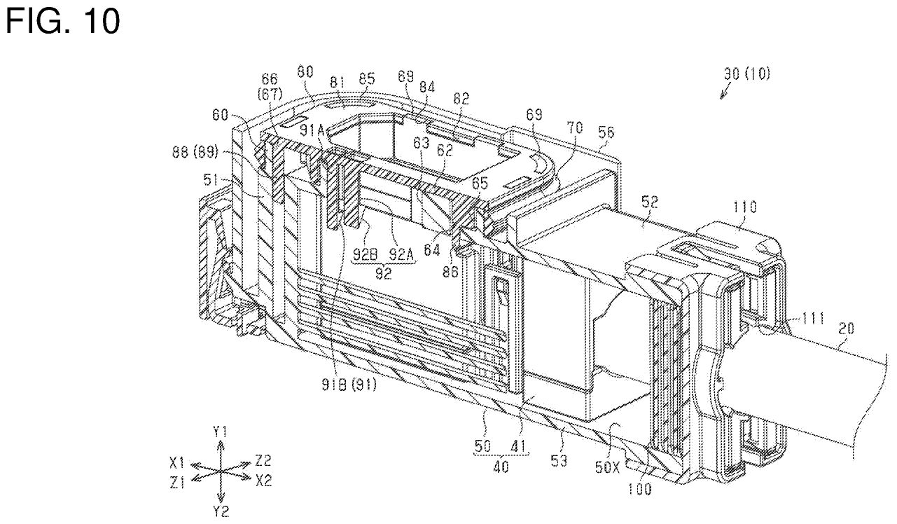

As shown in FIG. 10, the second engaging projections 92B particularly are formed to be engageable with the end surface substantially in the second opposite direction Y2 of the partition wall 62 of the tube portion 60.

For example, the second engaging projections 92B particularly are provided to be engageable with the end surface in the second opposite direction Y2 of the partition wall 62 when the retainer 80 is further pushed or displaced in the second opposite direction Y2 from the temporarily fixed state.

The respective second engaging portions 92 and the partition wall 62 are, for example, engaged with each other particularly by snap fitting utilizing the resilient deformation of the second resilient pieces 92A.

The retainer 80 particularly is fixed to the outer housing 50 by the engagement of the respective second engaging portion(s) 92 and the partition wall(s) 62.

In this fixed state, the retainer 80 particularly is fixed to the outer housing 50, for example, with the body portion 81 of the retainer 80 held substantially in contact with the end surface in the second direction Y1 of the tube portion 60.

In the fixed state, the first engaging projections 91B particularly are provided at positions separated from the end surface in the second opposite direction Y2 of the partition wall 62 and the first engaging portion(s) 91 and the partition wall(s) 62 are disengaged.

As shown in FIG. 4, in the fixed state, the tip of the terminal position assuring portion 86 particularly is at least partly inserted in the accommodating portion 50X of the outer housing 50 and/or provided at a position to be engageable with the engaging surfaces 45 of the inner housings 41 in the first direction X1. That is, the terminal position assuring portion 86 in the fixed state particularly restricts movements of the terminal(s) 31 and the inner housing(s) 41 substantially in the first opposite direction X2.

### (Configuration of Sealing Members 100)

As shown in FIG. 2, the one or more (e.g. two) sealing members 100 are respectively mounted on the one or more (e.g. two) wires 20. The (particularly each) sealing member 100 is mounted or mountable on the outer peripheral surface of the insulation coating 22 of the (particularly each) wire 20.

The (particularly each) sealing member 100 particularly is formed into a tubular shape continuously surrounding the outer periphery of each wire 20 particularly over the substantially entire circumference in the circumferential direction.

The (particularly each) sealing member 100 particularly seals between the outer peripheral surface of the wire 20 and the inner peripheral surface of the outer housing 50. The (each) sealing member 100 is, for example, made of rubber.

### (Configuration of Back Retainer 110)

The back retainer 110 is, for example, mounted on an end part in the first opposite direction X2 of the outer housing 50. The back retainer 110 particularly prevents the sealing members 100 from coming out from the outer housing 50. The back retainer 110 is, for example, provided to close an opening in the first opposite direction X2 of the outer housing 50.

As shown in FIG. 8, the back retainer 110 particularly includes one or more wire through holes 111, through which the one or more respective wires 20 are or can be passed.

The (particularly each) wire 20 is passed through the sealing member 100 and the back retainer 110 substantially in the first opposite direction X2 and/or pulled out to the outside of the outer housing 50.

Next, functions and effects of this embodiment are described.

(1) The connector 30 is provided with the one or more terminals 31 to be connected to (particularly the end parts) of the one o more wires 20 and/or the housing 40 including the accommodating portion 50X for at least partly accommodating the terminals 31 substantially along the first direction X1 inside and/or the tube portion 60 substantially open in the second direction Y1 intersecting the first direction X1 and/or communicating with the accommodating portion 50X.

The connector 30 particularly is provided with the sealing member 70 mounted on the outer periphery of the tube portion 60 and\hat{ }/or the retainer 80 for preventing the detachment of the sealing member 70 from the housing 40.

The retainer 80 particularly includes the terminal position assuring portion 86 for restricting movements of the terminals 31 substantially in the first opposite direction X2.

According to this configuration, the retainer 80 for retaining the sealing member 70 particularly is provided with the terminal position assuring portion 86 for restricting the movements of the terminals 31 substantially in the first opposite direction X2. In this way, one component, i.e. the retainer 80, can advantageously have both a function of retaining the sealing member 70 and a function of assuring the position(s) of the terminal(s) 31 particularly by restricting the movements of the terminals 31 substantially in the first opposite direction X2.

Thus, the number of components of the connector 30 can be reduced as compared to the case where the function of retaining the sealing member 70 and the terminal position assuring function are respectively given to different members. As a result, assembling man-hours of the connector 30 can be reduced, wherefore the assembly workability of the connector 30 can be improved.

(2) The end surface in the second direction Y1 of the tube portion 60 particularly is provided with the one or more, particularly the plurality of protrusions 69 projecting substantially in the second direction Y1 from that end surface. Thus, a separation distance of the sealing member 70 from the housing 40 can be made longer by the protrusion(s) 69 as compared to the case where the protrusion(s) 69 is/are not provided. In this way, the detachment of the sealing member 70 from the housing 40 can be suitably suppressed in a state before the retainer 80 is mounted on the housing 40.

(3) The protrusions 69 particularly are provided at least on the four corners of the rectangular or polygonal outer peripheral edge of the tube portion 60. Thus, even if the sealing member 70 moves to the plurality of protrusions 69 in the second direction Y1, the shape of the sealing member 70 can be suitably maintained in the same shape as when the sealing member 70 is mounted on the outer periphery of the tube portion 60, i.e. in a rectangular or polygonal tubular shape. In other words, even if the sealing member 70 moves to the plurality of protrusions 69, the sealing member 70 can be suitably suppressed from being deformed to enter the inside of the tube portion 60.

(4) In the retainer 80, the retaining portion 85 projecting radially outward from the frame-shaped body portion 81 particularly is provided to be engageable with the sealing member 70 substantially in the second direction Y1. Thus, a movement of the sealing member 70 substantially in the second direction Y1 particularly is restricted by the retaining portion 85. In this way, the detachment of the sealing member 70 from the housing 40 can be suitably suppressed.

(5) The first guide protrusion 89 having the larger projection amount than the terminal position assuring portion 86 particularly is provided on the retainer 80, and the first guide recess 67, into which the first guide protrusion 89 at least partly is fit, is provided in the housing 40. Thus, when the retainer 80 is mounted on the housing 40, the terminal position assuring portion 86 particularly can be at least partly inserted into the accommodating portion 50X of the housing 40 with the first guide protrusion 89 at least partly fit in the first guide recess 67. In this way, the terminal position assuring portion 86 particularly can be at least partly inserted into the accommodating portion 50X with the retainer 80 suitably maintained in a desired posture or orientation with respect to the housing 40.

(6) The retainer 80 particularly is provided with the at least one reinforcing portion 87 for reinforcing the terminal position assuring portion 86. In this way, the strength of the terminal position assuring portion 86 can be improved.

(7) The retainer 80 particularly includes the first engaging portion(s) 91 for temporarily fixing the retainer 80 to the tube portion 60 without the terminal position assuring portion 86 being at least partly inserted in the accommodating portion 50X. Since the terminal position assuring portion 86 is not inserted in the accommodating portion 50X in the temporarily fixed state, the terminal position assuring portion 86 is not engaged with the terminal(s) 31 substantially in the first direction X1. Thus, the one or more terminals 31 at least partly can be inserted into the accommodating portion 50X of the housing 40 after the retainer 80 is temporarily fixed to the tube portion 60.

(8) Movements of the inner housing(s) 41 substantially in the first opposite direction X2 particularly are restricted by engaging the engaging surface(s) 45 of the inner housing(s) 41 and the terminal position assuring portion(s) 86 of the retainer 80. In this way, movements of the terminal(s) 31 at least partly accommodated inside the inner housings 41 in the first opposite direction X2 particularly can be suitably restricted.

(9) The tube portion 60 particularly is provided with the through hole 64 substantially communicating with the accommodating portion 50X of the housing 40.

Thus, the terminal position assuring portion 86 can be suitably at least partly inserted into the accommodating portion 50X through the through hole 64 of the tube portion 60.

### (Other Embodiments)

The above embodiment can be modified and carried out as follows. The above embodiment and the following modifications can be carried out in combination without technically contradicting each other.
The structure of the first engaging portion 91 in the retainer 80 of the above embodiment can be changed as appropriate. If the first engaging portion 91 has, for example, a structure engageable with the housing 40, other structures can be changed as appropriate.
The one or more first engaging portions 91 in the retainer 80 of the above embodiment may be at least partly omitted.
The structure of the second engaging portion 92 in the retainer 80 of the above embodiment can be changed as appropriate. If the second engaging portion 92 has, for example, a structure engageable with the housing 40, other structures can be changed as appropriate.
The structure of the reinforcing portion 87 in the retainer 80 of the above embodiment can be changed as appropriate. For example, the substantially planar shape of the reinforcing portion 87 when viewed from the second direction Y1 can be changed as appropriate.
The reinforcing portion 87 in the retainer 80 of the above embodiment may be omitted. In this case, the recess 65 of the tube portion 60 particularly is also omitted.
The structure of the guide protrusion 88 in the retainer 80 of the above embodiment can be changed as appropriate. For example, the length of the first guide protrusion 89 particularly may be changed as appropriate. For example, the length of the first guide protrusion 89 along the second direction Y1 particularly may be set equal to or shorter than that of the terminal position assuring portion 86 along the second direction Y1.

For example, the second guide protrusion 90 may be omitted. In this case, the second guide recess 68 of the tube portion 60 is also omitted.
The guide protrusion 88 in the retainer 80 of the above embodiment may be omitted. In this case, the guide recess 66 of the tube portion 60 is also omitted.
Although the one or more inner housings 41 and the one or more outer housing 50 are separate components in the housing 40 of the above embodiment, there is no limitation to this. For example, the one or more inner housings 41 and the one or more outer housing 50 may be integrally formed.
The structure of the inner housing 41 of the above embodiment can be changed as appropriate. If the inner housing 41 has, for example, a structure capable of accommodating the terminal 31 and has the engaging surface 45, other structures can be changed as appropriate.
Although the inner housing 41 particularly is composed of two or more divided bodies, e.g. the first and second divided bodies 46, 47, in the above embodiment, there is no limitation to this. For example, the inner housing 41 may be composed of three or more divided bodies. For example, the inner housing 41 particularly may be composed of a single component.
Although the inner housing 41 particularly is provided individually for each of the plurality of terminals 31 in the above embodiment, there is no limitation to this. The one or more, particularly the plurality of terminals 31 may be collectively accommodated into one inner housing 41.
The inner housings 41 in the above embodiment may be omitted. In this case, the one or more terminals 31 are, for example, directly accommodated into the accommodating portion 50X of the outer housing 50. In this case, the terminal position assuring portion 86 may be, for example, provided to be directly engaged with the one or more terminals 31 substantially in the first direction X1.
The structure of the outer housing 50 of the above embodiment can be changed as appropriate. If the outer housing 50 includes, for example, the tube portion 60, on or to which the sealing member 70 is mounted, and has a structure, on or to which the retainer 80 is mountable, other structures can be changed as appropriate. For example, the number and/or formation positions of the protrusions can be changed as appropriate. For example, the one or more protrusions 69 may be omitted. In this case, the fitting holes 84 in the retainer 80 particularly are also omitted. For example, the receptacle 56 of the outer housing 50 may be omitted.
Although the sealing members 70, 100 particularly are embodied as rubber rings in the above embodiment, there is no limitation to this. For example, ring members made of a resilient material other than rubber may be adopted as the sealing members 70, 100.
Although the connector 30 of the above embodiment particularly includes the two terminals 31, the connector 30 may include one, three or more terminals 31.

Accordingly, to provide a connector and a wiring harness capable of improving assembly workability, a connector 30 is provided with a terminal 31 to be connected to an end part of a wire 20 and a housing 40 including an accommodating portion 50X for at least partly accommodating the terminal 31 substantially along a first direction X1 inside and a tube portion 60 substantially open in a second direction Y2 intersecting the first direction X1 and at least partly communicating with the accommodating portion 50X. The connector 30 is provided with at least one sealing member 70 mounted to the tube portion 62, particularly on an outer periphery of the tube portion 60, and at least one retainer 80 for preventing detachment of the sealing member 70 from the housing 40. The retainer 80 includes at least one terminal position assuring portion 86 for restricting a movement of the terminal 31 in a first opposite direction X2 opposite to the first direction X1.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector (30), comprising:
at least one terminal (31) to be connected to at least one wire (20);
a housing (40) including at least one accommodating portion (50X) for at least partly accommodating the terminal (31) along a first direction (X1) inside and a tube portion (60) substantially open in a second direction (Y2) intersecting the first direction (X1), the tube portion (60) communicating with the accommodating portion (50X);
at least one sealing member (70) mounted to the tube portion (60), particularly on an outer periphery of the tube portion (60); and
at least one retainer (80) for preventing detachment of the sealing member (70) from the housing (40),
the retainer (80) including at least one terminal position assuring portion (86) for restricting a movement of the terminal (31) in a first opposite direction (X2) opposite to the first direction (X1).

2. The connector according to claim 1, wherein:
the housing (40) includes one or more protrusions (69) projecting in the second direction (Y1) from an end surface in the second direction (Y1) of the tube portion (60), and
the retainer (80) includes one or more fitting holes (84), the one or more protrusions (69) being at least partly fit or fittable into the one or more fitting holes (84).

3. The connector according to claim 2, wherein:
an outer peripheral edge of the tube portion (60) is formed to have a rectangular or polygonal plan view shape when viewed from the second direction (Y1), and
the plurality of protrusions (69) are provided at least on four corners of the rectangular or polygonal shape.

4. The connector according to claim 1, wherein:
the retainer (80) includes:
a body portion (81) formed into a frame shape, the body portion (81) covering the end surface in the second direction (Y1) of the tube portion (60);
the terminal position assuring portion (86) projecting in a second opposite direction (Y2) substantially opposite to the second direction (Y1) from the body portion (81); and
at least one retaining portion (85) projecting radially outwardly of the body portion (81) from the body portion (81), and
the retaining portion (85) is provided to be engageable with the sealing member (70) substantially in the second direction (Y1).

5. The connector according to claim 4, wherein:
the retainer (80) includes at least one guide protrusion (88) projecting substantially in the second opposite direction (Y2) from the body portion (81),
the housing (40) includes at least one guide recess (66) at least partly to be fit to the guide protrusion (88), and
a projection amount of the guide protrusion (88) from the body portion (81) is larger than that of the terminal position assuring portion (86) from the body portion (81).

6. The connector according to claim 4, wherein:
the retainer (80) includes at least one reinforcing portion (87) continuously and integrally formed with the terminal position assuring portion (86) to reinforce the terminal position assuring portion (86),
the reinforcing portion (87) projects substantially in the second opposite direction (Y2) from the body portion (81), and
a projection amount of the reinforcing portion (87) from the body portion (81) is smaller than that of the terminal position assuring portion (86) from the body portion (81).

7. The connector according to claim 1, wherein the retainer (80) includes:
a first engaging portion (91) for temporarily fixing the retainer (80) to the tube portion (60) without the terminal position assuring portion (86) being inserted in the accommodating portion (50X); and/or
a second engaging portion (92) for fixing the retainer (80) to the tube portion (60) with the terminal position assuring portion (86) inserted in the accommodating portion (50X) and the movement of the terminal (31) in the first opposite direction (X2) restricted.

8. The connector according to claim 1, wherein:
the housing (40) includes:
at least one inner housing (41) for at least partly accommodating the terminal (31) inside; and
an outer housing (50) including the accommodating portion (50X) for at least partly accommodating the at least one inner housing (41) inside,
the inner housing (41) has an engaging surface (45) formed to be engageable with the terminal position assuring portion (86) in the first direction (X1), and
the terminal position assuring portion (86) restricts a movement of the inner housing (41) in the first opposite direction (X2).

9. The connector according to claim 1, wherein:
the tube portion (60) includes at least one through hole (64), the terminal position assuring portion (86) at least partly being inserted into the through hole (64) along a second opposite direction (Y2) substantially opposite to the second direction, (Y1) and
the through hole (64) penetrates through the tube portion (60) in the second direction (Y1) and substantially communicates with the accommodating portion (50X).

10. A wiring harness (10), comprising:
the connector (30) according to claim 1; and
the wire (20) connected to the connector (30).
